(19) United States
(12) Patent Application Publication
(10) Pub. No.: US 2011/0041780 A1
(43) Pub. Date: Feb. 24, 2011

(54) Therapeutic gel pad

(76) Inventor: Marni Markell Hurwitz, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/655,447

(22) Filed: Dec. 30, 2009

Related U.S. Application Data
(63) Continuation-in-part of application No. 12/583,550, filed on Aug. 21, 2009.

(51) Int. Cl. A01K 13/00

(52) U.S. Cl. 119/850

(57) ABSTRACT

A therapeutic gel pad for household pets and farm animals is worn on a pet's injured or sensitive body part to facilitate healing and provide protection or treatment. The therapeutic gel pad includes a base gel layer and an upper gel layer appointed to intimately contact a body region of the household animal and/or farm animal. The therapeutic gel pad may comprise a massaging gel sole or may comprise a gel inner layer or gel pad and may be provided with a securing member for securing the pad to the animal's body. Advantageously, the therapeutic gel pad may directly deliver medicament to the injury. It may also provide cold treatment or hot treatment therapies, while providing cushioning, shock absorption and protection from dirt and debris.

### CROSS-REFERENCE TO RELATED APPLICATIONS

This application is a continuation-in-part of U.S. patent application Ser. No. 12/583,550, filed Aug. 21, 2009, the disclosure of which is hereby incorporated in its entirety by reference thereto.

### BACKGROUND OF THE INVENTION

1. Field of the Invention

The present invention relates to a therapeutic gel pad; and more particularly to a therapeutic gel pad for household and farm animals comprising a bottom/base gel layer secured to an upper/top gel layer with healing properties integrated therein that is appointed to be used on different areas of an animal's body for soothing or treating discomfort, such as to the paw or hoof area, joints, elbow discomfort, eye protection, or after surgery.

2. Description of the Prior Art

Injury to a pet animal's paw, including dogs and cats, requires a proper healing environment. Healing of injured paws can be frustrated due to overuse of the leg/paw, licking, scratching or biting by the pet, and/or contact with dirt or debris. Infection is also a concern during the healing process. While bandages are frequently used they do not provide optimal protection, are easily compromised and do not generally provide therapeutic properties integrated therein. Bandages used to wrap an injured paw need to be replaced often and do not provide optimal protection as they absorb moisture, do not provide a shock absorbent nature, readily become dirty and are commonly chewed on by the pet. Moreover, no therapeutic gel pad for household animals and farm animals has been proposed which is appointed to treat, protect and message various parts of an animal's body, such as a paw or hoof, leg, joints, torso, back region, eye's, or other parts of the body while providing cushioning, protection from shock and meddling by the pet, preventing entry of dirt, and promoting a sanitary healing environment with therapeutic properties to facilitate healing.

While prior art has addressed shoes and/boots for animals for wear outside during inclement or cold weather, as well as for aesthetic purposes, no therapeutic gel pad has been proposed. Such prior art patents considered include: U.S. Pat. No. 4,458,431 to Sinclair (protective boot for pet animals has a sole member and a flexible upper); U.S. Pat. No. 5,495,828 to Solomon, et al. (pet animal boot including a pliable sleeve defining an open top end and a closed lower end, substantially conforms to the animal's paw and lower leg, contains an interior fabric liner, and is manufactured from a waterproof, non-slip, flexible and durable polymer solution); U.S. Pat. No. 4,744,333 to Taylor (protective footwear including a two-piece bootee comprises a sock of warm and comfortable yarn which is inserted into and joined to a boot of deerskin and suspender system); U.S. Pat. No. 3,762,073 to Cantales (disposable protective legging for a dog comprising a first and second sheet of flexible heat sealable thermoplastic material shaped to generally conform to the shape of a dog's leg); U.S. Pat. No. 3,747,565 to Kellam (pair of boots with means secured to the boots that extend along the leg and body portions of the animal to retain the boots on the paws); U.S. Pat. No. 5,408,812 to Stark (dog boot for use on a hunting dog having a lower paw-receiving portion of flexible, moisture-resistant material, and a generally tubular elongate legging portion extending upwardly); and U.S. Pat. No. 5,148,657 to Stafford et al. (dog boot having a foot, ankle and calf).

Various insoles have been provided for human foot use. These insoles are not constructed for a canine or feline (or other pet) paws and do not provide an external pet boot in conjunction therewith. A canine, feline (or other pet) paw is distinctly structurally distinct from a human foot. Accordingly these gel pads would need manipulation and reconstruction to perform as a paw bed for a pet. Examples of insoles for human feet can be found in U.S. Pat. No. 6,631,568 to Howlett, et al., U.S. Pat. Nos. 7,140,126 and 6,598,321 to Crane et al.; and U.S. Pat. No. 6,598,319 to Hardt.

In contrast to the efforts of prior art workers which heretofore have simply constructed pet boots and shoes to be worn by a pet when outdoors to prevent injury or insoles for human feet, there is a need in the art for a therapeutic gel pad appointed to be worn by a pet to facilitate healing. There additionally remains a need in the art for a therapeutic gel pad that has therapeutic properties and which is appointed to be worn on various parts of an animal's body to promote well being, provide treatment to injuries, or to provide protection from dirt and shock absorption, such as during healing.

### SUMMARY OF THE INVENTION

The present invention provides a therapeutic gel pad especially suited to be worn by a pet when the animal is injured, sensitive, or necessitates cushioning, protection from dirt and shock absorption, such as during healing. Therapeutic properties are achieved by constructing a therapeutic gel pad having an internal therapeutic member that intimately contacts and protects the sensitive or injured body part. The therapeutic gel pad herein has particular applications geared toward use on an injured paw, hoof, leg, joints, eyes, head, torso, back and/or stomach. The therapeutic gel pad can be utilized on a sensitive body part of an animal\in need of comfort, such as with an older dog, cat, horse, or farm animal. Controlled release of a medicament and/or a scent can be delivered through the therapeutic member which, in one embodiment, is constructed having at least one reservoir or a plurality of pockets/capsules appointed with at least one aperture that is adapted to release medicament upon pressure being applied to the inner therapeutic member. Application of pressure to the inner therapeutic member surface causes the reservoir or pockets to fracture and the medicament to release onto the local body region.

The therapeutic gel pad can be made in a variety of shapes and sizes and can be used on different parts of the animal's body for the protection and for soothing areas of discomfort. Treatments may include for example: elbow discomfort; treatment after stomach surgery; eye protection, and the like. Where necessary, the therapeutic gel pad is placed and secured in position by way of a gel pad strap, which is preferably made from nylon material, or the like, with fastener mechanisms integrated therein, including for example hook and loop closures such as those sold under the trade name VELCRO®, clips, snaps, ties, and adhesive. During application for example onto a horse's hoof, the therapeutic gel pad fits comfortably into the hoof of an animal, radiating a cooling or heating agent, medicament, and the like. The therapeutic gel pad may vary in shape, thickness, size, etc.

Generally stated, the therapeutic gel pad includes a base gel layer bonded in at least one portion to an upper gel layer appointed to intimately contact a body region of a household animal or farm animal. The therapeutic gel pad is appointed to be worn on the animal's body region to provide comfort thereto. Healing of the injury is facilitated through wear of the therapeutic gel pad. Advantageously, the gel pad may directly deliver medicament to the paw or injured body region to provide cold treatment or hot treatment therapies, while providing cushioning, shock absorption and protection from dirt and debris.

The therapeutic gel pad is composed of a gel material that enhances comfort to the pet, including dog, cat, equine, or farm animals such as cattle, llamas, sheep, etc. Preferably, wherein the therapeutic gel pad is provided as an insole for the animal's paw or hoof, massaging gel structures are utilized so that when the animal walks a massaging effect is created on the paw to promote blood circulation and increase the overall health and comfort of the pet, and aid healing. The therapeutic gel pad (and optional bootee insole) and the massaging gel insole are composed of a silicon or polymeric material preferably having a movable fluid paw bed or foot bed; or a visco-elastic gel to provide shock absorption and consequently protection to the paw or hoof. An absorbent top cloth may be adhered to the upper surface of therapeutic gel pad (and optional bootee insole) or the massaging gel insole to absorb moisture from the paw and enhance comfort. The absorbent top cloth may be a resilient foam that conforms to the paw pad of the pet when pressure is applied.

The top gel layer and bottom or base gel layer is secured by adhesive, RF welding, or any other appropriate means. Each of these layers is composed of a fluid impermeable material. The bottom gel layer is preferably made from a non-foam elastomer such as the class of materials known as viscoelastic polymers or silicone gels, which show high levels of damping when tested by dynamic mechanical analysis performed in the range of −50° C. to 100° C. Mechanical properties of the gel have greater viscosity than elasticity. Therefore, the gel provides a high energy absorption. Gels that can be used according to the present invention are thermoplastic elastomers (elastomeric materials), such as materials made from many polymeric families, including but not limited to the Kraton family of styrene-olefin-rubber block copolymers, thermoplastic polyurethanes, thermoplastic poly olefins, polyamides, polyureas, polyesters and other polymer materials that reversibly soften as a function of temperature. The preferred elastomer is a Kraton block copolymer of styrene/ethylene-co-butylene/styrene or styrene/butadiene/styrene with mineral oil incorporated into the matrix as a plasticizer.

In accordance with another aspect of the invention, parallel, spaced apart wave pattern resilient walls may be formed within the therapeutic gel pad, causing the pad to become a massaging gel insole. These resilient walls are spaced by sinusoidal grooves to from wave patterns on the paw bed or foot bed of the bootee or insole. Spacing between adjacent resilient walls may vary, and for example may be approximately 3 mm, which varies in accordance with the width of each wall, the size of the paw pad or insole, and with changes in the amplitude of the sinusoidal grooves. The pitch of the wave pattern may also be varied. Various gel insoles are currently sold in the market for human feet, such as those sold under the tradename Dr. Scholl's® (massaging gel insoles and inserts). These insole constructs may be applied to form the gel insoles herein. Gel insoles for human feet are differently shaped and configured than those for canine and feline paws. Up until the time of the present invention no gel insole has been constructed or provided for a canine or feline paw. The subject invention uniquely addresses problems resultant from paw injury to canines and felines (as well as other pawed pets). In accordance with the invention, it has been found that use of the therapeutic pet boot, as described herein, facilitates healing through a massaging gel action during recovery.

The therapeutic gel pad may be constructed in a plethora of shapes and sizes, depending on the therapeutic need. The pad is not only appointed to be utilized to treat paws and/or hooves, but is also provided to treat other body regions. Preferably, the pad is provided as an elongated strip, rectangle, triangle, or other shaped portions to treat different body regions. The therapeutic gel pad may be formed as a gel insole for a paw or hoof of said animal. It may also be formed as a glove to house a paw which can be slipped into the glove opening. Alternatively, the therapeutic gel pad may be provided as a joint pad, torso or back pad, or as a head or eye protective pad. In these applications the shape of the therapeutic gel pad may be modified to conform with the area appointed for treatment.

Alternative embodiments of the therapeutic gel pad provide cold therapy to the animal. Preferably, cold therapy is facilitated by placing the therapeutic gel pad in a refrigerator or freezer to reduce the temperature thereof and provide a cold treatment without substantially increasing pad hardness or otherwise changing its texture. The therapeutic gel pad is constructed with a polymeric top and bottom layer adhered together to form a reservoir or pocket therein. This reservoir or pocket receives and houses a non-toxic material, preferably hydroxyethyl cellulose (sold under the trade name Cellusize™) or vinyl-coated silica gel or a granular, vitreous, highly porous form of silica made synthetically from sodium silicate. Another type of cold therapeutic gel pad which may be used concerns cold treatment resultant from an endothermic reaction of ammonium nitrate and water for quick cooling.

Warm/hot treatment may be provided by the therapeutic gel pad as well. Preferably, warm therapy is achieved by the therapeutic gel pad via a hot water bottle type warming or chemical heat pack. Preferably, a hot water bottle type therapeutic gel pad is used where the pad is reusable and where safety is a concern.

Medicament can be directly delivered to the paw or hoof or injured body region through use of the therapeutic gel pad. In this embodiment the therapeutic gel pad includes a reservoir housing medicament. The upper gel layer comprises a therapy pocket appointed to house medication therein which is secreted through at least one aperture. Such medication can include a plethora of medicines or treatments, for example including anesthetizing substances, antiseptic or an ointment. Advantageously, topical delivery of the medicament or ointment is achieved in a manner wherein the dog or cat/equine/livestock cannot lick the product. For example, for dry or cracked paw pads or hooves a lotion or moisturizer may be delivered by the therapeutic gel pad and a covering may be placed over the pad.

The reservoir housing the anesthetizing substances, antiseptic, ointment, or lotion, etc. may be a single reservoir or may be comprised of a plurality of reservoirs in the form of a plurality of pockets) or a plurality of capsules—that readily release the medicament, etc. to the animal's body region as pressure is applied. The medicament, etc. may be released by the application of pressure to the external surface or external top layer of the pad. This application of pressure causes the reservoir, pockets or capsules to break, releasing the medicament, lotion, etc., housed therein. Due to the arrangement of the capsules within the pad, the medicament, etc. is released at the interface between the animal's body region and top of the pad enabling the medicament to contact the injury. Replenishment of the medicament is optionally available through use of replacement shields or membranes wherein the medicament is encapsulated. The shields are readily placed over the gel pad when the refurbishment of the initial medicament supply is required. Dispersing of the medicament is determined by its volume, viscosity and its surface tension. Since pockets contain a larger volume of the medicament or treatment, they can be spaced apart further, based on the volume.

A method for treating an injury of a pet with a therapeutic gel pad is also provided. The method comprises the steps of: (i) placing an injured body region of the pet against the therapeutic gel pad, the therapeutic gel pad comprising a base gel layer and an upper gel layer appointed to intimately contact a body region of the household animal or farm animal; (ii) securing the therapeutic gel pad against the body region with a securing member; and (iii) wearing the therapeutic gel pad by the pet for a period of time to facilitate healing of the injured body region.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1a is a schematic view of an embodiment of the therapeutic gel pad wherein the pad is constructed as a massaging gel insole for an animal's paw, such as a dog or cat;

FIG. 1b is a cross-sectional view of the embodiment of FIG. 1a taken along line X-X;

FIG. 2a is a top view of an embodiment of the therapeutic gel pad wherein the pad is constructed as a massaging gel insole for an animal's paw, such as a dog or cat bootee insole and/or the massaging gel insole;

FIG. 2b is a cross-sectional view of the patch of FIG. 2a taken along line M-M;

FIG. 3 is a view of an embodiment of the therapeutic gel pad wherein the pad is constructed for a hoof.

FIG. 4 is a view of an embodiment of the therapeutic gel pad wherein the pad is constructed for a hoof;

FIG. 5a is a top view of an embodiment of the therapeutic gel pad wherein the pad is constructed as a pad for an animal's back, such as a horse, and wherein the pad is being worn under a saddle to provide comfort and therapy to the horse's back;

FIG. 5b is a view of the pad of FIG. 5a;

FIG. 6a is a top view of an embodiment of the therapeutic gel pad wherein the pad is formed as an insole shaped and conformed to massage the paw pad;

FIG. 6b is a cross-sectional view of the patch of FIG. 6a taken along line Y-Y;

FIG. 7 is a top view of an embodiment of the therapeutic gel pad shaped and conformed to massage the paw pad and include massaging gel reservoirs;

FIG. 8 is a top view of an embodiment of the therapeutic gel pad wherein the pad includes massaging gel reservoirs;

FIG. 9 is a top view of an embodiment of the therapeutic gel pad shaped and conformed to massage the paw pad and include medicament releasing pocket;

FIG. 10 is a top view of an embodiment of the therapeutic gel pad wherein the pad includes a medicament releasing pocket;

FIG. 11 is a top view of an embodiment of the therapeutic gel pad shaped and conformed to massage the paw pad and include a plurality of medicament releasing pockets;

FIG. 12a is a top view of an embodiment of the therapeutic gel pad wherein a plurality of medicament releasing pockets is provided;

FIG. 12b is a cross-sectional view taken along line I-I in FIG. 12a;

FIG. 13a is a top view of an embodiment of the therapeutic gel pad removably housed within a cover;

FIG. 13b is a top view of the cover without the therapeutic gel pad housed therein; and

FIG. 14 illustrates a view of an embodiment of a securing member, wherein the member is provided as a band having fastener means integrated therein along with a slot appointed for receiving a therapeutic gel pad.

### DETAILED DESCRIPTION OF THE INVENTION

The present invention provides a gel pad having therapeutic properties including healing properties, and which is appointed to be used on an animal when it's injured. Regions of the animal's body which may be treated include the paw or hoof, leg, joints, back, neck, head, eyes, knees, elbows, torso, etc. The pad can be constructed in a number of different shapes and sizes without departing from the general constructs of the invention. The pad provides the ability to treat an injury, or treat sensitive body regions by providing treatment, protection and shock absorption. A securing member is provided to secure the therapeutic gel pad onto the animal. Preferably the securing member is weather resistant and composed of a fibrous, rubber, silicone, polymeric (and preferably polyvinyl chloride), leather, suede material or combinations thereof.

The therapeutic pad may comprise a massaging gel pad or gel pad having a bladder therein holding a gel, liquid, and/or air pockets. Alternatively, the therapeutic pad may be composed of a fibrous foam material. In other embodiments, the therapeutic pad may directly deliver medicament or provide cold treatment or hot treatment therapies to the injury, while providing cushioning, shock absorption and protection from dirt and debris. Depending on the treatment needed, the therapeutic pad is appointed to be removably housed within the securing member so that it can be interchanged or adjusted.

The therapeutic pad is composed of a gel material that enhances comfort as well as provides support for the pet. Massaging gel structures may be utilized so that when the animal walks or rolls over a massaging effect is created on the paw or back, respectively, to promote blood circulation and increase the overall health and comfort of the pet. The therapeutic pad is composed of a silicon or polymeric material preferably having a movable fluid bed or a visco-elastic gel to provide shock absorption and consequently protection to the animal. An absorbent top cloth may be adhered to the upper surface of therapeutic pad to absorb moisture and enhance comfort. The absorbent top cloth may be resilient foam that conforms to the body region to which it is applied. It may also comprise a membrane overlay that is adapted to adhesively adhere to the gel pad and contains a replenishing supply of medicament.

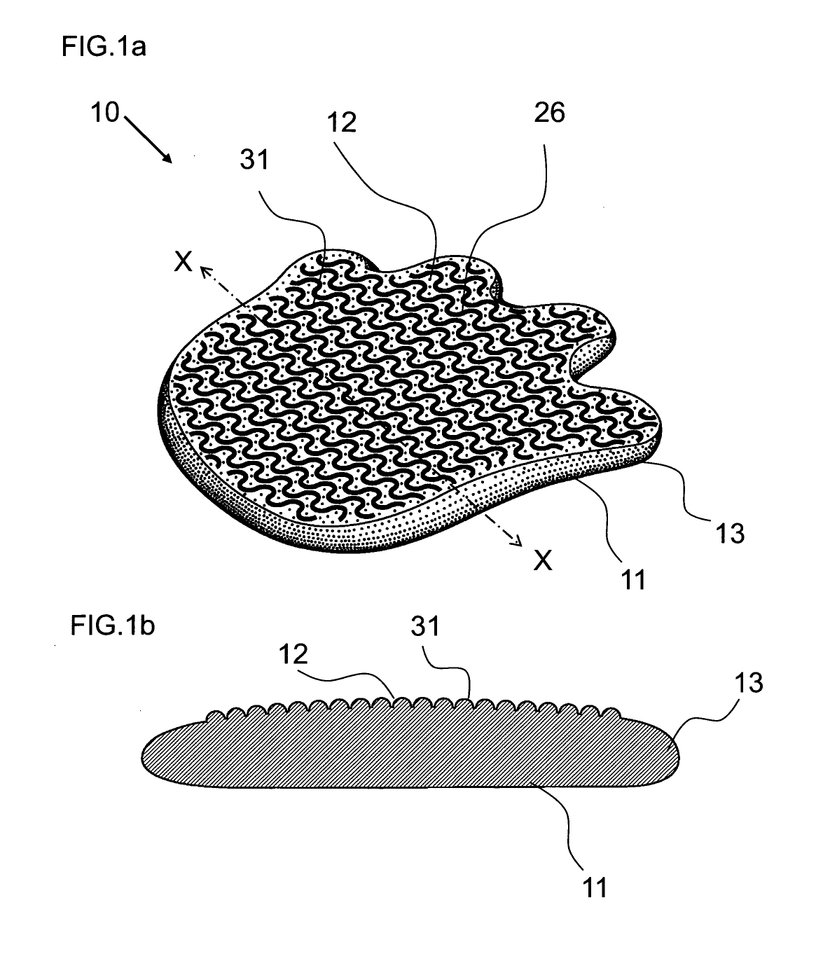

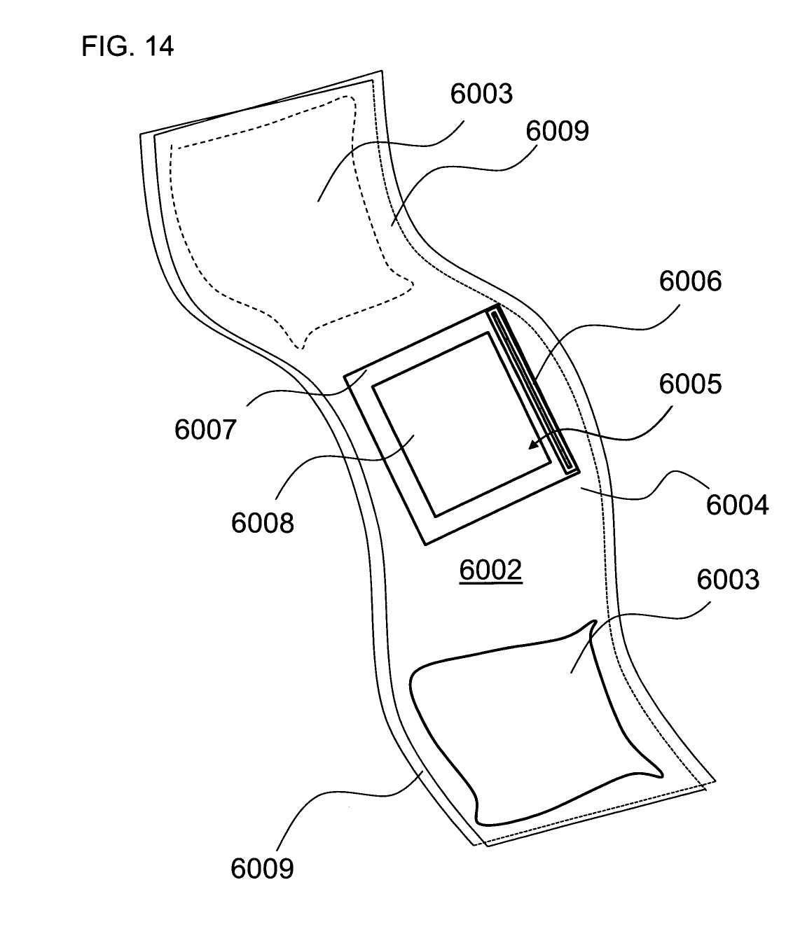

FIGS. 1a-1b illustrate a first embodiment of the therapeutic pad wherein the pad is constructed as a massaging gel insole for an animal's paw, such as a dog or cat, shown generally at 10. The therapeutic pad 10 comprises a base gel layer 11 bonded to an upper gel layer 12 at side seams 13. Upper gel layer 12 is appointed to intimately contact a body region of a household animal or farm animal. Although the embodiment shown in this figure is for a paw, the pad can have a plethora of shapes and sizes for use on other body regions of an animal without departing from the invention herein. The therapeutic gel pad 10 is appointed to be worn on the paw of an animal to provide comfort. At least one securing member may be provided to secure the therapeutic pad 10 to the pet during wear (for example, see FIG. 14). The securing member (FIG. 14) may be formed as a band having elastic properties and fastener means such as hook and loop fasteners for securing the band, and consequently the pad, onto the pet.

In the embodiment shown herein, therapeutic pad comprises a gel pad having a paw shape. The gel pad is composed of a gel material that enhances comfort as well as provides support for the pet's paw, legs, and lower back. Preferably, the gel pad is constructed as a massaging gel so that when the animal walks a massaging effect is created on the paw. The gel pad promotes blood circulation within the paw thereby increasing the overall health and comfort of the pet. The gel pad may be composed of a silicon or polymeric material including a movable fluid or a visco-elastic gel to provide shock absorption and consequently protection to the paw. An absorbent top cloth may be adhered to the upper surface or upper layer 12.

The gel layers, 11 and 12, are preferably made from a non-foam elastomer such as the class of materials known as viscoelastic polymers or silicone gels, which show high levels of damping when tested by dynamic mechanical analysis performed in the range of −50° C. to 100° C. Mechanical properties of the gel have greater viscous than elastic effect, and therefore the gel provides a high energy absorption. Gels that can be used according to the present invention are thermoplastic elastomers (elastomeric materials), such as materials made from many polymeric families, including but not limited to the Kraton family of styrene-olefin-rubber block copolymers, thermoplastic polyurethanes, thermoplastic poly olefins, polyamides, polyureas, polyesters and other polymer materials that reversibly soften as a function of temperature. The preferred elastomer is a Kraton block copolymer of styrene/ethylene-co-butylene/styrene or styrene/butadiene/styrene with mineral oil incorporated into the matrix as a plasticizer. Upper layer 12 may include a paw pad/bed 26 that is slightly concave to enhance massage and contact on the paw pad of the animal. Concave digital pads may also be provided for the smaller paw pads on the animal's paw.

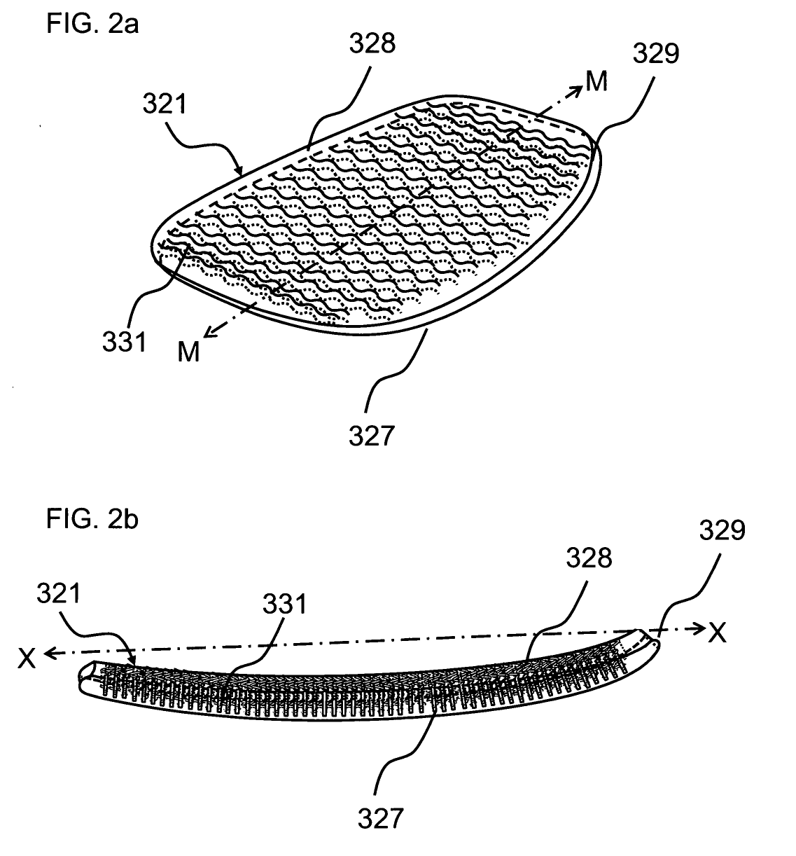

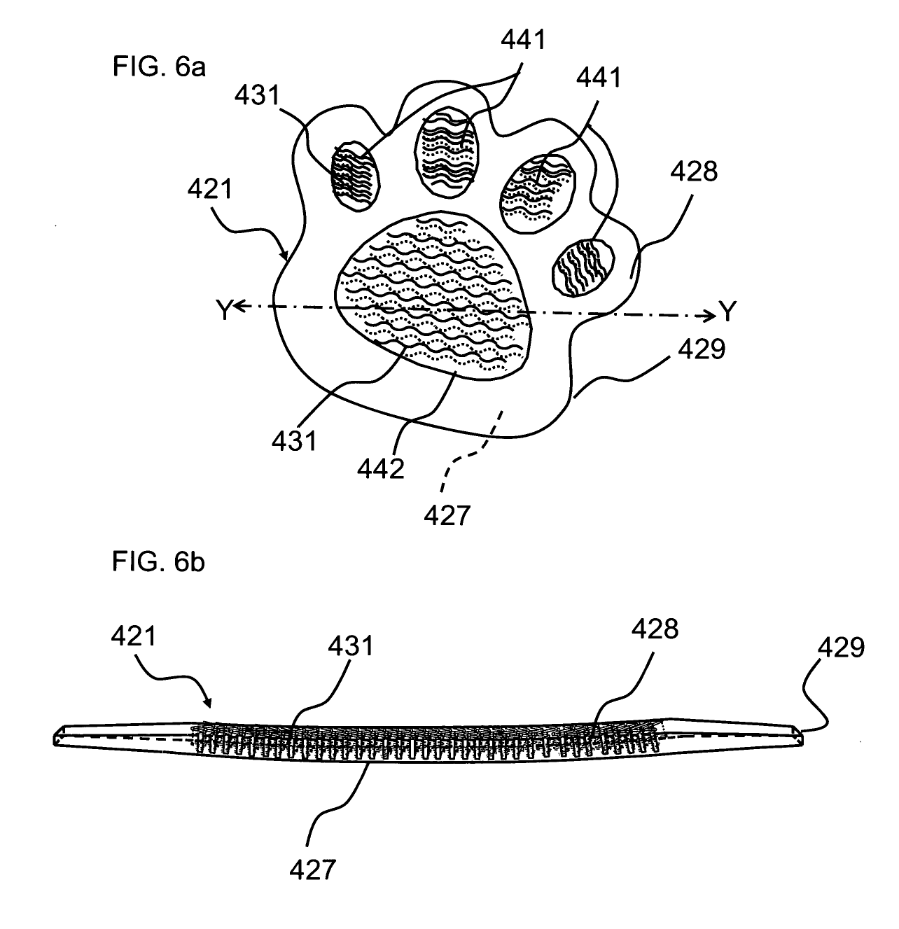

Although the gel pad is shown herein with messaging wave patterns, the gel pad may be provided as a resilient gel cushioning, air cushioning, or as a cold/warm pad or as a medicament releasing pad as discussed hereinafter. Gel pad 10 is shown having spring walls 31 constructed therein for massaging the paw while walking. As best illustrated in FIGS. 2a, 2b and 6a, 6b these spring walls are parallel, spaced apart, sinusoidal shaped wave patterns. Spacing of approximately 3 mm between adjacent rows is provided, but such spacing may vary.

FIG. 2a is a top view of an embodiment of the therapeutic gel pad wherein the pad is constructed as a massaging gel insole for an animal's paw, such as a dog or cat bootee insole or the massaging gel insole. FIG. 2b is a cross-sectional view of the patch of FIG. 2a taken along line M-M. Referring generally to FIGS. 2a, 2b, 6a and 6b, an insole 321, 421 is shown which may be appointed as a gel insole for insertion into a gel bootee or appointed for securement to the paw by way of the securing member such as shown in FIG. 14. A silicon or polymeric material including a movable fluid or a visco-elastic gel may be used to construct the insole 321, 421. Gel insole 321, 421 is preferably formed having a bottom/base gel layer 327, 427 and an upper/top gel layer 328, 428 secured by adhesive, RF welding, or any other appropriate means at sides 329, 429. The layers 327, 328 (427, 428) are preferably made from a non-foam elastomer such as the class of materials known as viscoelastic polymers or silicone gels. Thermoplastic elastomers (elastomeric materials), such as materials made from many polymeric families, including but not limited to the Kraton family of styrene-olefin-rubber block copolymers, thermoplastic polyurethanes, thermoplastic poly olefins, polyamides, polyureas, polyesters and other polymer materials that reversibly soften as a function of temperature may be used. The preferred elastomer is a Kraton block copolymer of styrene/ethylene-co-butylene/styrene or styrene/butadiene/styrene with mineral oil incorporated into the matrix as a plasticizer.

During construction, preferably by injection molding, bottom/base gel layer 327, 427 is selected and formed in the shape of the insole 321, 421. In the event that an adjustment of the gel pad is required, the shape can be contoured by cutting to the desired configuration. An upper/top gel layer 328, 428 is also formed into the shape of insole 321, 421 via injection molding and the layers 327 and 328 (427 and 428) are bonded together at sides 329, 429 by an adhesive, RF welding, or any other appropriate means. The bootee gel insole or massaging gel insole 321, 421 may comprise polyurethane surrounding a material selected from a group consisting of gel, liquid silicone, or polyurethane foam, wherein bottom/base gel layer 327, 427 and upper/top gel layer 328, 428 are constructed as polyurethane and bonded on sides 329, 429.

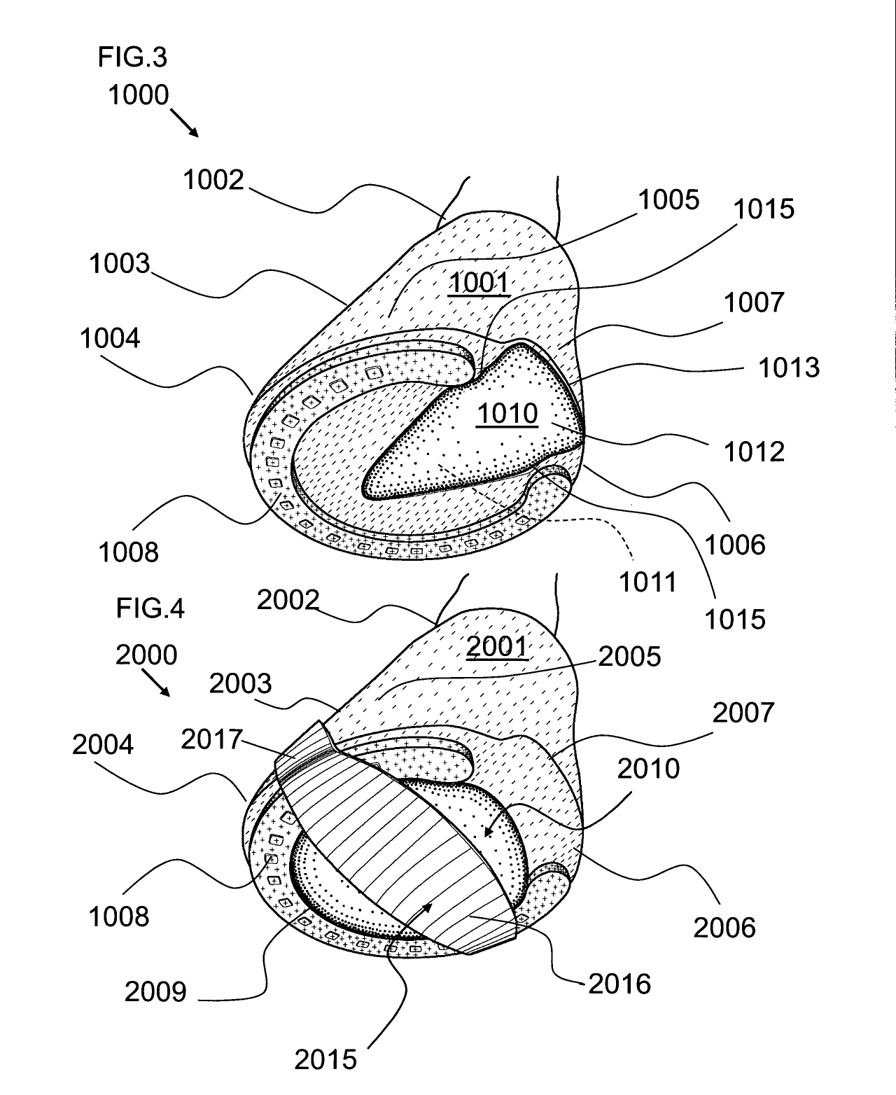

In the embodiment shown, the insole 321, 421 includes spring walls 331, 431 for massaging the paw. Preferably, these spring walls 331, 431 are parallel, spaced apart, sinusoidal shaped wave patterns. Spacing of approximately 3 mm between adjacent rows is provided, but same may vary based on the size of the insole 321, 421. The insole 321, 421 may have a slightly arced configuration as shown by line x-x in FIG. 3b, for comfortably slightly embracing the paw pad of an animal's paw. As shown in FIG. 6a, the insole 421 may be constructed having digital pads 441 and a metacarpal pad 442, each of which may include massaging characteristics (herein shown as sinusoidal shaped spring waves 431), or alternatively the whole paw-shaped pad of FIG. 6a may have massaging characteristics. Spring walls 331,431 are preferably formed by molding or pressing them in the bottom/base layer 327, 427 and top/upper layer 328, 428 after they are bonded together via molding of sinusoidal shaped wave press.

Parallel, spaced apart, wave pattern resilient walls may be formed within the gel bootee (and/or optional bootee insole) and/or the massaging gel insole. These resilient walls are spaced by sinusoidal grooves to from wave patterns on the paw bed or foot bed of the bootee or insole. Spacing between adjacent resilient walls may vary, and for example may be approximately 3 mm, which varies dependent upon the width of each wall, size of the paw pad/insole, and by changing the amplitude of the sinusoidal grooves. Pitch of the wave pattern may also be varied. Various gel insoles are currently sold in the market for human feet, such as those sold under the trade name Dr. Scholl's® (massaging gel insoles and inserts). However, gel insoles for human feet are differently shaped and configured than those for canine and feline paws and up until the time of the present invention herein no gel insole has been constructed or provided for a canine or feline paw. Uniquely, the subject invention herein addresses problems resultant from paw injury to canines and felines (as well as other pawed pets). Advantageously, it has been found that use of the therapeutic pet boot herein facilitates healing through massaging gel action during recovery.

The pad is constructed so that when the animal walks a massaging effect is created on the paw. Blood circulation is promoted within the paw thereby increasing the overall health and comfort of the pet. The insoles may be formed in the shape of a paw including a paw pad and toe paw pad regions as shown in 6a for example, or may have a general shape that may be subject to trimming with scissors.

FIG. 3 is a view of an embodiment of the therapeutic gel pad wherein the pad is constructed for a hoof, shown generally at 1000. A horse's hoof, or other farm animal's hoof, is shown at 1001. Hoof 1001 is provided having a coronet band 1002, walls 1003, toe 1004, quarter 1005, heel 1006, and central groove 1007. A horseshoe 1008 is attached to the hoof 1001. A therapeutic gel pad 1010 is placed within the central groove 1007 of the hoof 1001. The therapeutic pad 1010 is constructed having a base gel layer 1011 bonded to an upper gel layer 1012 at side seams 1013. Upper gel layer 1012 is in intimately contact with the central groove 1007. Although the embodiment shown in this figure is shaped like a pie or triangle, the shape can take any form suitable for covering the bottom of the hoof 1001. In the embodiment shown, the pad 1010 is held into place at corners 1015 thereof by way of horseshoe 1008.

The pad 1010 may be constructed as discussed herein concerning FIGS. 1-14. For example, the therapeutic pad 1010 may be constructed as a massaging gel so that when the animal walks a massaging effect is created on the paw. The gel pad 1010 promotes blood circulation within the hoof thereby increasing the overall health and comfort of the horse. Gel pad 1010 may be composed of a silicon or polymeric material including a movable fluid or a visco-elastic gel to provide shock absorption and consequently protection to the paw. The gel layers, 1011 and 1012, are preferably made from a non-foam elastomer such as the class of materials known as viscoelastic polymers or silicone gels. Mechanical properties of the gel have greater viscous than elastic effect; and therefore the gel provides a high energy absorption. Gels that can be used according to the present invention are thermoplastic elastomers (elastomeric materials), such as materials made from many polymeric families, including but not limited to the Kraton family of styrene-olefin-rubber block copolymers, thermoplastic polyurethanes, thermoplastic poly olefins, polyamides, polyureas, polyesters and other polymer materials that reversibly soften as a function of temperature. The preferred elastomer is a Kraton block copolymer of styrene/ethylene-co-butylene/styrene or styrene/butadiene/styrene with mineral oil incorporated into the matrix as a plasticizer. The upper layer 1012 of the gel pad 1010 may include messaging wave patterns (as in FIGS. 2a, 2b and 6a, 6b), a resilient gel cushioning, air cushioning, or as a cold/warm pad or as a medicament releasing pad as discussed hereinafter.

FIG. 4 is a view of an embodiment of the therapeutic gel pad wherein the pad is constructed for a hoof, shown generally at 2000. A horse's hoof, or other farm animal's hoof, is shown at 2001. Hoof 2001 is provided having a coronet band 2002, walls 2003, toe 2004, quarter 2005, heel 2006, central groove 2007 and sole 2009. A horseshoe 2008 is attached to the hoof 2001. A therapeutic gel pad 2010 is placed within the sole 2009 of the hoof 2001. The therapeutic pad 2010 is constructed as described herein, such as shown in FIG. 3. The embodiment of the pad 2010 shown in this figure is shaped like a disc or plate. In the embodiment shown, the pad 2010 is held into place by a securing member 2015. Securing member 2015 is formed as a band having a central segment 2016 and side straps 2017. Side straps 2017 oppose one another and each have a fastener means integrated therein, such as hook and loop fastener 2018 such as that sold under the trade name VELCRO®.

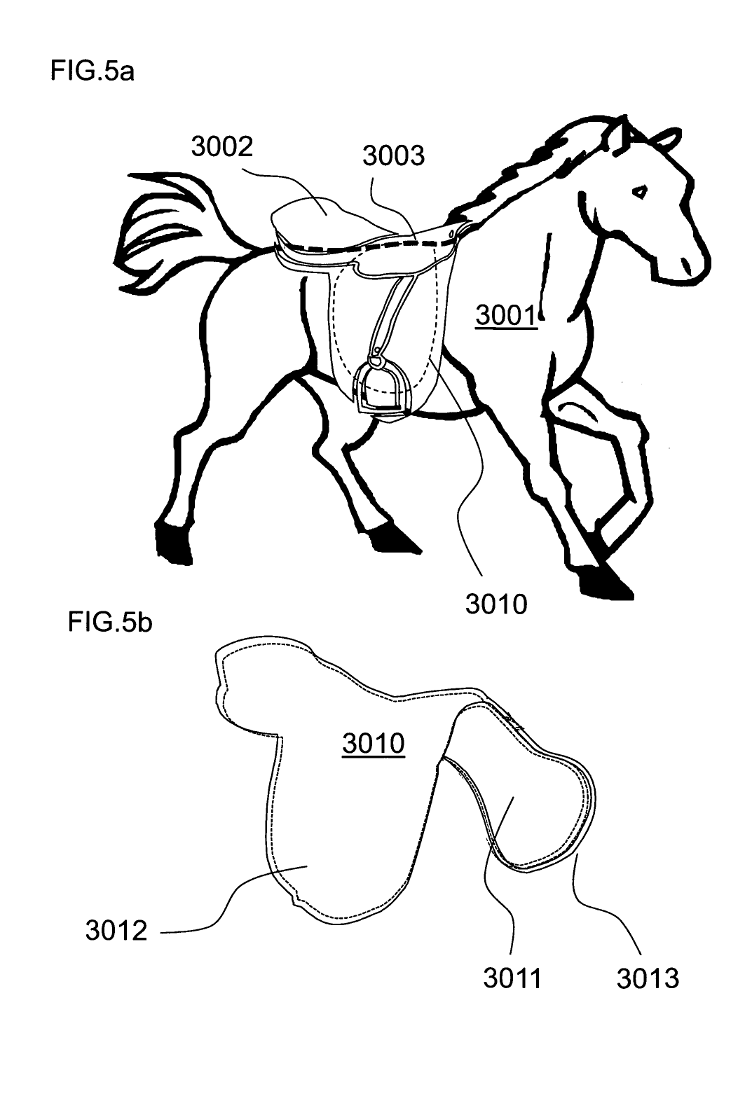

FIG. 5a is a top view of an embodiment of the therapeutic gel pad wherein the pad is constructed as a pad for an animal's back, such as a horse, and wherein the pad is being worn under a saddle to provide comfort and therapy to the horse's back. FIG. 5b is a view of the pad of FIG. 5a, wherein a horse 3001 is shown. A saddle 3002 is placed upon the horse's back 3003. Under the saddle 3002 and in direct intimate contact with the horse's back 3003 is a therapeutic gel pad 3010. The therapeutic pad 3010 is constructed having a base gel layer 3011 bonded to an upper gel layer 3012 at side seams 3013. A reservoir 3014 may be provided between the gel layers 3011, 3012, as discussed hereinafter in FIGS. 6-12. The embodiment of the pad 3010 shown in this figure is shaped to form an arc for snuggly hugging the horse's back 3003 to create warmth or cooling or additional comfort. In the embodiment shown, the pad 3010 is held into place by way of saddle 3002; however a securing member that acts as a band/belt traversing around the horse's midsection may be used.

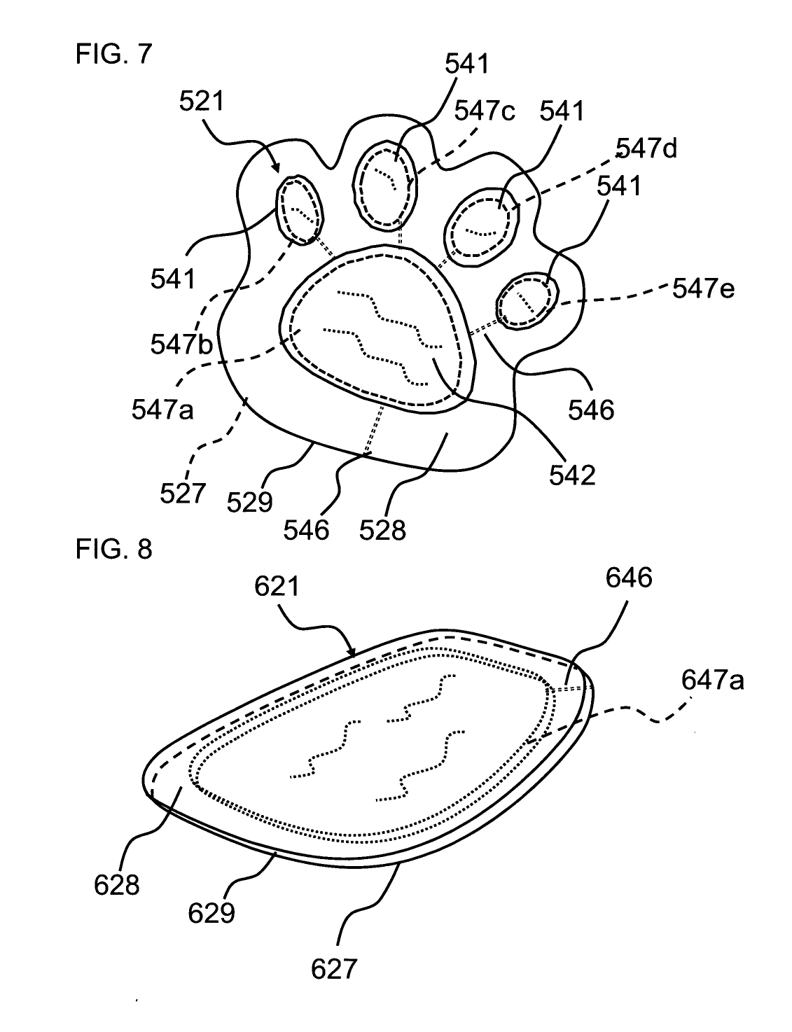

FIG. 7 is a top view of an embodiment of the therapeutic gel pad shaped and conformed to massage the paw pad and include massaging gel reservoirs. The pad may be shaped to conform to a plethora of shapes and sizes, such as those discussed hereinabove concerning FIGS. 1-6, for example. FIG. 8 is a top view of an embodiment of the therapeutic gel pad shaped in a polygonal shape and includes massaging gel reservoirs. Any shaped therapeutic gel pad may be utilized. Therapeutic gel pad 521, 621 is preferably made from a silicon or polymeric material including a movable fluid or a visco-elastic gel. Therapeutic gel pad 521, 621 is preferably formed having a bottom/base gel layer 527, 627 and an upper/top gel layer 528, 628 secured by adhesive, RF welding, or any other appropriate means at sides 529, 629 and/or between digital pads 541 and metacarpal pad 542. Layers 527, 528 (627, 628) may comprise polyurethane surrounding a material selected from a group consisting of gel, liquid silicone, or polyurethane foam, or air pockets/a plurality of capsules of compressed air wherein bottom/base gel layer 527, 627 and upper/top gel layer 528, 628 are constructed as polyurethane and bonded on sides 529, 629. As shown in FIG. 7, each digital pad 541 and metacarpal pad 542 may include massaging characteristics as shown; or the entire pad may be constructed with a massaging reservoir or pocket such as shown in FIG. 8, which may be shaped as a polygon or may be shaped as a plethora of shapes. In formation, layers 527, 627 and 528, 628 are bonded together save for injection ports 546, 646 from which gel, liquid silicone, polyurethane foam, water, or air are injected into reservoirs 547a-n, 647a-n after which time injection ports 546, 646 are closed and sealed via bonding/adhesive. The therapeutic gel pads can be made from other methods concerning the formation of gel pads and are not limited to the method herein.

Alternatively, the therapeutic gel pad is adapted to provide cold therapy to the animal. To facilitate cold therapy, the therapeutic gel pad is placed in a refrigerator or freezer to reduce the temperature thereof, for a cold treatment. The therapeutic gel pad has polymeric top and bottom layers adhered together to form a reservoir or pocket therein, which receives and houses a non-toxic material, preferably hydroxyethyl cellulose (sold under the trade name Cellusize™) or vinyl-coated silica gel or a granular, vitreous, highly porous form of silica made synthetically from sodium silicate. Another type of gel pad ice pack which may be used involves cold treatment resultant from an endothermic reaction of ammonium nitrate and water for quick cooling. Cold treatment is achieved by an endothermic reaction, which occurs when water is in a reservoir of the gel pad along with a small plastic bag or tube containing ammonium-nitrate. When the bag or tube is broken, the water mixes with the fertilizer to create an endothermic reaction that reduces the temperature of the bag or tube to approximately 35 F for 10 to 15 minutes. Other chemicals which produce a similar effect include calcium chloride and ammonium chloride. Owing primarily to safety concerns, the refrigerator or freezer cold pad is more preferable for regular use than the chemical reaction cold treatment pad herein disclosed. However, chemical cold gel pads can be used in limited circumstances, such as when a pet needs quick cold treatment. Formation of the pad is achieved in a similar method as described in reference to the drawings, with the exception that the liquid or gel injected into each of the reservoirs 547a-n, 647a-n includes the non-toxic material, preferably hydroxyethyl cellulose (sold under the trade name Cellusize™) or vinyl-coated silica gel or a granular, vitreous, highly porous form of silica made synthetically from sodium silicate, or insertion of ammonium nitrate and water within metacarpal pad 542 for quick endothermic cooling.

Warm/hot treatment may be provided by the therapeutic gel pad as well to provide warm therapy. Preferably, warm therapy is achieved by way of the therapeutic gel pad via a hot water bottle type warming gel pad or chemical heat pad pack. Preferably, hot water bottle type pads are used where the pad is reusable and where safety is a concern. The therapeutic gel pad utilizes the pad construction but further includes a small reservoir therein containing a material such as water having a high specific heat capacity, which then gradually releases the heat over time. Chemical pads may be utilized in the constructs of the pad by employing a chemical heat reservoir or a one-time chemical reaction such as catalyzed rusting of iron. A sodium acetate heat pad may be provided within the pad provided as a reusable heat reservoir. It contains a supersaturated solution of sodium acetate (NaCH₃COO). Crystallization is triggered by flexing a small flat disc of notched ferrous metal embedded in the liquid. Pressing the disc releases very tiny adhered crystals of sodium acetate into the solution which then act as nucleation sites for the recrystallization of the remainder of the salt solution. Because the liquid is supersaturated, the solution crystallizes rapidly, thereby releasing the energy of the crystal lattice. The pad can be reused by placing it in boiling water for 10-15 minutes. This re-dissolves the sodium acetate in the contained water and recreates a supersaturated solution. Once the pad has returned to room temperature it can be triggered again. Preferably, an insulating pocket is provided for placement of the pad to insulate the heat of the warm/heated pad. Formation of the pad is achieved in a similar method as described hereinabove, with the exception that the liquid or gel injected into each of the reservoirs 547a-n, 647a-n includes the high specific heat capacity, which then gradually releases the heat over time, such as water, wherein the pad is appointed to be heated in hot water using the low-temperature control on a microwave. Chemical pads may be employed in the constructs of the pad by employing a chemical heat reservoir or a one-time chemical reaction, such as catalyzed rusting of iron. This is typically accomplished by inserting a supersaturated solution of sodium acetate (NaCH₃COO) into each of the reservoirs 547a-n, 647a-n and then allowing same to cool to room temperature for use.

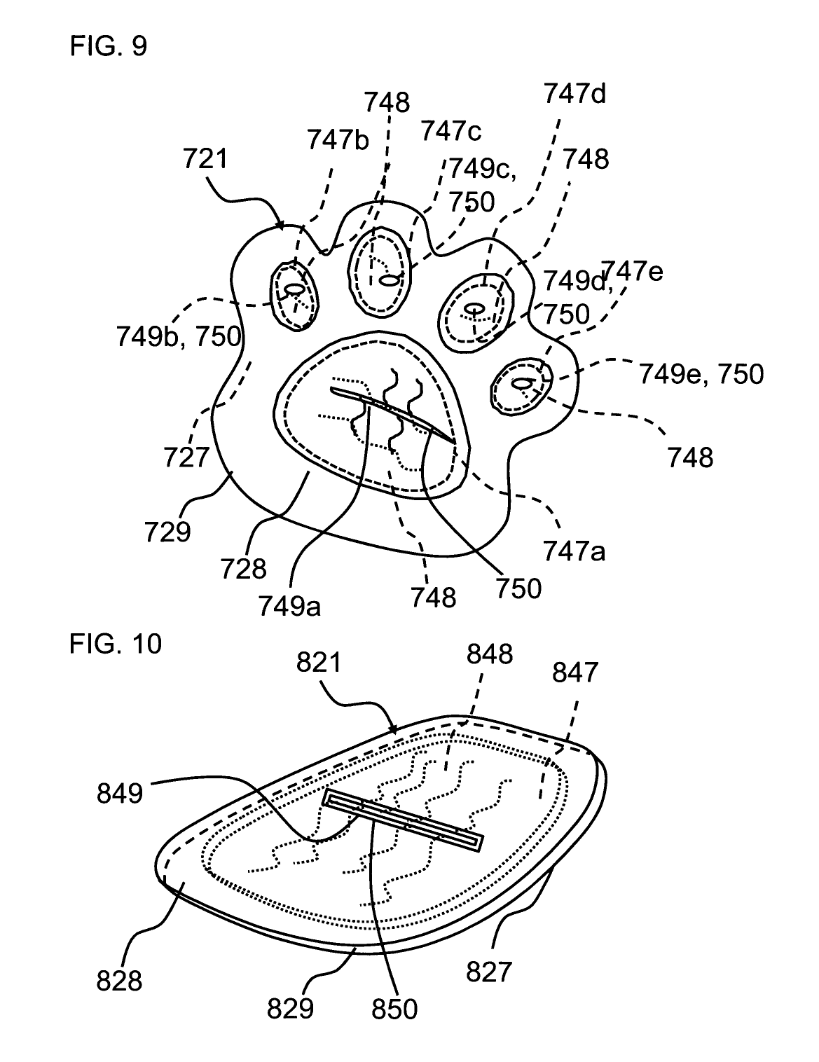

FIG. 9 is a top view of an embodiment of the therapeutic gel pad shaped and conformed to massage the paw pad and include a medicament releasing pocket. FIG. 10 is a top view of an embodiment of the therapeutic gel pad wherein the pad includes a medicament releasing pocket. Gel pad 721, 821 comprises at least one pocket/reservoir 747a-n, 847a-n appointed to house medication 748, 848 therein which is secreted through at least one aperture 749a-n, 849a-n in the upper layer of the pad to the injured paw. Aperture 749a-n, 849a-n includes a breakable polymeric cover or thin membrane 750, 850 that readily ruptures when force in the form of the animal's weight is applied to the insole 721, 821.

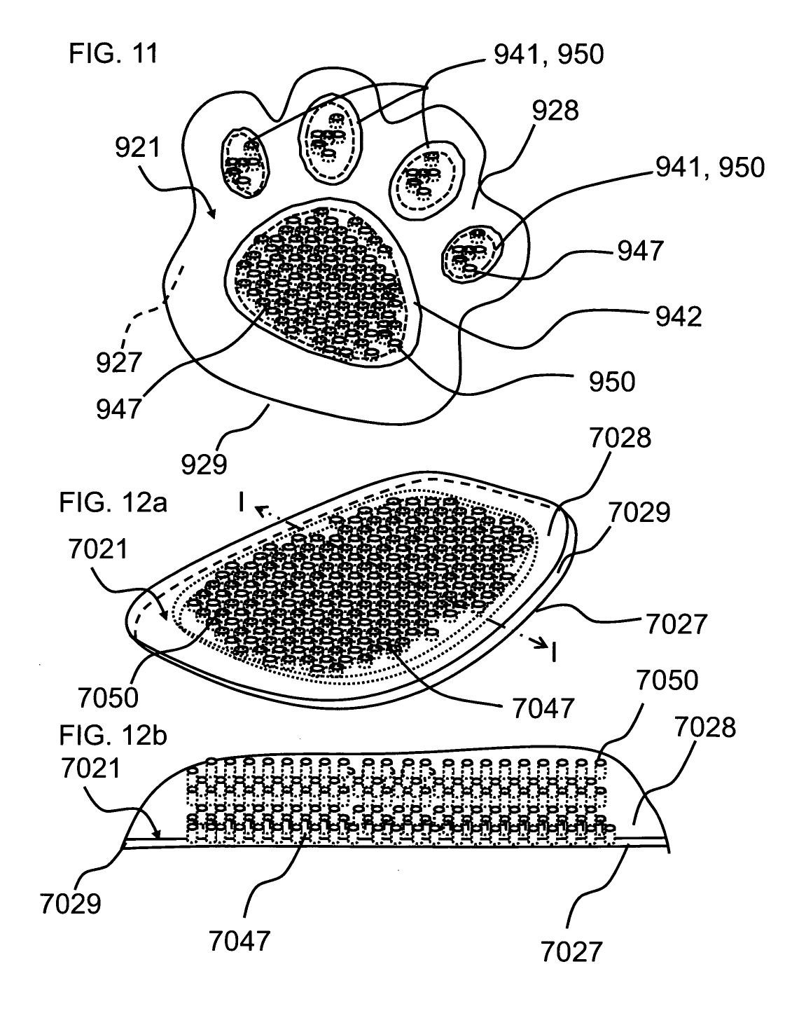

Formation of the pad 721, 821 is achieved in a similar method as described in reference to FIGS. 7 and 8, with the exception that the liquid or gel injected into each of the reservoirs 747a-n, 847a-n is that of the medicament, ointment, lotion, or antiseptic, etc. Medicament can be directly delivered to the paw/body region through use of the pad 721, 821 or by means of a membrane of the type previously described, which contains a replenishing supply thereof. Such medication 748, 848 can include a plethora of medicines or treatments, for example including anesthetizing substances, antiseptic or an ointment, or may include a lotion or oil for treatment of cracked or dry paw pads/body regions. Advantageously, topical delivery of the medicament or ointment is achieved in a manner wherein the dog or cat cannot lick the product. The reservoirs 747a-n, 847a-n housing the anesthetizing substances, antiseptic, ointment, or lotion, etc., may be a single reservoir or may be comprised of a plurality of reservoirs in the form of a plurality of pockets or a plurality of capsules as shown in FIGS. 11 and 12—that readily release the medicament, etc. to the paw/body region as pressure is applied.

The medicament, etc. may be released by the application of pressure to the external surface or external top layer 728, 828 of the pad 721, 821. This application of pressure causes the reservoir 747a-n, 847a-n, pockets or capsules to break, releasing the medicament, lotion, etc., housed therein (748, 848). Due to the arrangement of the pockets/reservoir 747a-n, 847a-n within the pad 721, 821, the medicament 748, 848, etc. is released at the interface between the paw pad and top of the pad 721, 821 enabling the medicament to contact the paw. The overall volume of the pockets or reservoir 747a-n, 847a-n determines the amount of the medicament or topical treatment available. Once released, the medicament or topical treatment is spread to an area at the paw-contact interface. The pockets/reservoir 747a-n, 847a-n may be spaced apart, and the size of the pockets may be provided dependent on the amount of medicament or topical treatment to be dispersed and the size of the pad.

The medicament or topical treatment may be contained in a plurality of small pockets within the pad as shown in FIGS. 11-12. FIG. 11 is a top view of an embodiment of the pad shaped and conformed to massage the paw pad and include a plurality of medicament releasing pockets; FIG. 12a is a top view of an embodiment of the pad that includes a plurality of medicament releasing pockets; FIG. 12b is a cross-sectional view taken along line I-I in FIG. 12a.

In this embodiment, the medicament or topical treatment is contained in capsules/pockets or reservoirs 947a-n, 7047a-n constructed within the pad 921, 7021. Pad 921, 7021 is preferably formed having a bottom/base gel layer 927, 7027 and an upper/top gel layer 928, 7028 secured by adhesive, RF welding, or any other appropriate means at sides 929, 7029 and/or between digital pads 941 and metacarpal pad 942 of FIG. 11. Layers 927, 928 (7027, 7028) may comprise polyurethane surrounding a material selected from a group consisting of gel, liquid silicone, or polyurethane foam, or air pockets/a plurality of capsules of compressed air wherein bottom/base gel layer 927, 7027 and upper/top gel layer 928, 7028 are constructed as polyurethane and bonded on sides 929, 7029. Pad 921, 7021 is formed via a bottom/base gel layer 927, 7027 and upper/top gel layer 928, 7028 composed of a fluid impermeable material. The gel layers are preferably made from a non-foam elastomer such as the class of materials known as viscoelastic polymers or silicone gels, which show high levels of damping. Gels that can be used according to the present invention are thermoplastic elastomers (elastomeric materials), such as materials made from many polymeric families, including but not limited to the Kraton family of styrene-olefin-rubber block copolymers, thermoplastic polyurethanes, thermoplastic poly olefins, polyamides, polyureas, polyesters and other polymer materials that reversibly soften as a function of temperature.

In the embodiment shown in FIGS. 11 and 12a, 12b, the upper/top gel layer 928, 7028 is embossed to create the pockets/reservoirs 947, 7047 and filled with the medicament. The shape of the packets/reservoirs 947, 7047 may be spherical, cylindrical or elongated or any suitable shape. The pockets/reservoirs 947, 7047 may be interconnected to form a continuous single pocket such as an interconnected channel. A thin polymeric sheet 950, 7050 is bonded to the upper/top gel layer 928, 7028 thereby encapsulating the medicament in the pockets/reservoirs 947, 7047 of the upper/top gel layer 928, 7028. The application of pressure to outer surface or exterior top layer of the pad 921, 7021, and visa vie the thin polymeric sheet 950, 7050, breaks the pockets/reservoirs 947, 7047 on the upper/top gel layer 928, 7028 thereby releasing the medicament. Alternatively, a single reservoir is formed which releases the medicament, as shown in FIGS. 9 and 10.

Disperse of the medicament is determined by its volume, viscosity and its surface tension. Since pockets contain larger volume of the medicament, they can be spaced apart further based on the volume. The volume is generally in the range of 0.01 cc to 0.5 cc and the spacing between the pockets is in the range of 0.01 cm to 0.2 cm. Capsules are generally small and contain only a small quantity of medicament, etc., and can only spread over a small distance approximating a few times the diameter of the microcapsule. These microcapsules may be added to the thin polymeric layer bonded to the top gel layer and are nearly uniformly dispersed. Rather than medication, the reservoirs or pockets may contain a lotion or scent emitting oil having scents such as roses, lavender, chamomile, etc. to mask or disguise a noxious odor.

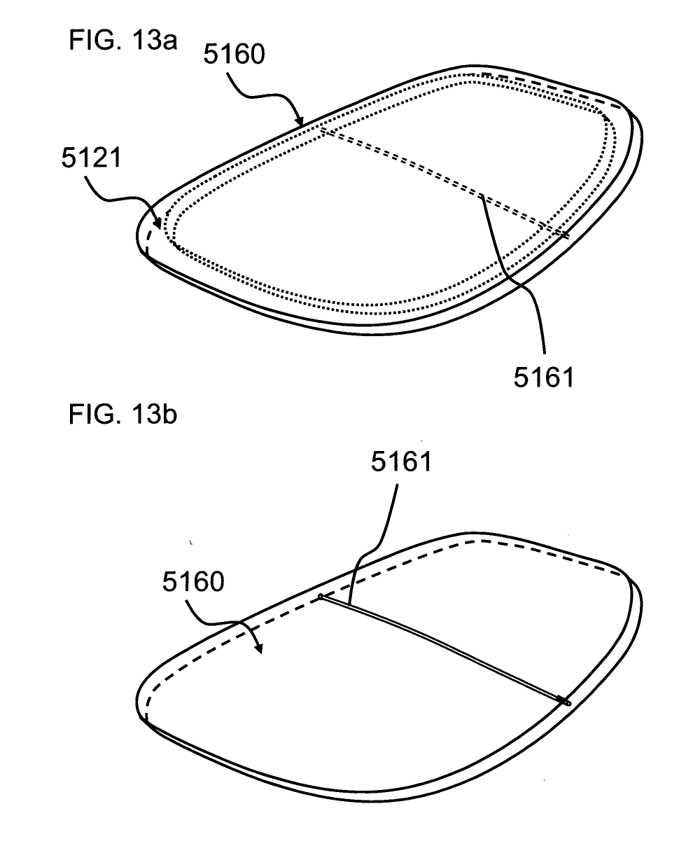

FIGS. 13a and 13b show views of a removable cover 5160 which may be used to house therapeutic pad 5070. The covering helps to keep the pad 5070 clean. The removable cover 5160 may be washed and reused. A slit 5161 may be provided for easy removal of pad 5070.

FIG. 14 illustrates a view of an embodiment of a securing member 6002, wherein the member is provided as a band having side arms 6009 with mating fastener means 6003 integrated therein. In the center 6004 of the band is provided a slot 6005 appointed for receiving and housing a therapeutic gel pad. The slot 6005 has an access opening 6006 for insertion of the pad. The slot 6005 may include a frame structure 6007 with an open center 6008 to provide direct contact of the therapeutic pad against the animal's body, as when the pad is appointed to deliver medicament or other direct application treatments. In like manner, a membrane appointed for adherence to the therapeutic pad can be used to provide a replenishing supply of medicament thereto.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A therapeutic gel pad for household animals or farm animals, comprising:
a. a base gel layer;
b. an upper gel layer operative to intimately contact a body region of said household animal or farm animal;
wherein said therapeutic gel pad is appointed to be worn on said animal's body region to provide comfort.

2. A therapeutic gel pad as recited by claim 1, wherein said therapeutic gel pad is a gel insole for a paw or hoof of said animal.

3. A therapeutic gel pad as recited by claim 1, wherein said therapeutic gel pad is a joint pad.

4. A therapeutic gel pad as recited by claim 1, wherein said therapeutic gel pad is a torso or back pad.

5. A therapeutic gel pad as recited by claim 1, wherein said therapeutic gel pad is a head or eye protector.

6. A therapeutic gel pad as recited by claim 1, wherein said base gel layer and said upper gel layer comprise polyurethane surrounding a material selected from a group consisting of gel, liquid silicone, or polyurethane foam.

7. A therapeutic gel pad as recited by claim 1, wherein said base gel layer and said upper gel layer comprise polyurethane surrounding capsules of compressed air.

8. A therapeutic gel pad as recited by claim 1, wherein said base gel layer and said upper gel layer comprise polyurethane surrounding a plurality of capsules of a liquid or gel.

9. A therapeutic gel pad as recited by claim 1, wherein said therapeutic gel pad is appointed to be placed in a refrigerator or freezer to reduce its temperature and thereby provide cold treatment.

10. A therapeutic gel pad as recited by claim 1, wherein said therapeutic gel pad is a heat pad appointed to deliver heat.

11. A therapeutic gel pad as recited by claim 1 comprising an insulating cover appointed to receive and house said therapeutic gel pad.

12. A therapeutic gel pad as recited by claim 1, wherein said upper gel layer comprises a therapy pocket appointed to house medication therein which is secreted through at least one aperture.

13. A therapeutic gel pad as recited by claim 1 comprising a removable cover or replaceable membrane containing a replenishing supply of medicament.

14. A therapeutic gel pad as recited by claim 1 comprising a massaging gel insole.

15. A therapeutic gel pad as recited by claim 14, wherein said massaging gel insole comprises polyurethane surrounding a material selected from a group consisting of gel, liquid silicone, or polyurethane foam.

16. A therapeutic gel pad as recited by claim 14, wherein said massaging gel insole comprises polyurethane surrounding capsules of compressed air.

17. A therapeutic gel pad as recited by claim 14, wherein said massaging gel insole is appointed to be placed in a refrigerator or freezer.

18. A therapeutic gel pad as recited by claim 14, wherein said massaging gel insole is a heat insole appointed to deliver heat to said injured paw or hoof.

19. A therapeutic gel pad as recited by claim 14, wherein said massaging gel insole comprises an insole pocket appointed to house medication therein which is secreted through at least one aperture to said injured paw.

20. A therapeutic gel pad as recited by claim 1 comprising scent emitting properties.

21. A therapeutic gel pad as recited by claim 1 comprising a reservoir housing a medicament which releases medicament when pressure is applied to said therapeutic gel pad.

22. A therapeutic gel pad as recited by claim 1 comprising a plurality of pockets or capsules appointed with at least one aperture that are appointed to release medicament when pressure is applied to said therapeutic gel pad.

23. A therapeutic gel pad as recited by claim 1 comprising a securing member appointed to secure said therapeutic gel pad to said animal during wear.

24. A method for treating an injury of a pet with a therapeutic gel pad, comprising said steps of:
a. placing an injured body region of said pet against said therapeutic gel pad, said therapeutic gel pad comprising a base gel layer and an upper gel layer adapted to intimately contact a body region of said household animal and/or farm animal;
b. securing said therapeutic gel pad against said body region with a securing member; and
c. wearing said therapeutic gel pad by said pet for a period of time to facilitate healing of said injured body region.
